(19) United States
(12) Patent Application Publication
(10) Pub. No.: US 2008/0012382 A1
(43) Pub. Date: Jan. 17, 2008

(54) INTEGRATION OF BUTTONS INTO A REACTION INJECTION MOLDED AUTOMOTIVE INSTRUMENT PANEL SKIN

(76) Inventor: Gregg S. Evans, Windsor (CA)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/621,768

(22) Filed: Jan. 10, 2007

Related U.S. Application Data
(60) Provisional application No. 60/757,885, filed on Jan. 11, 2006.

(51) Int. Cl. B62D 25/14

(52) U.S. Cl. 296/70; 156/70; 156/87; 428/411.1

(57) ABSTRACT

A method of manufacturing an automotive instrument panel including providing an electrical button, placing the button in a mold, and reaction injection molding a skin layer of the instrument panel to substantially fully encapsulate the button so that the button is substantially fully integrated with the skin layer and further includes a substantially zero gap fit with the instrument panel.

### RELATED APPLICATIONS

This application claims benefit of priority of Provisional Application Ser. No. 60/757,885, filed Jan. 11, 2006, hereby incorporated by reference in its entirety.

### BACKGROUND OF INVENTION

a. Field of Invention

The invention relates generally to the manufacture of automotive instrument panels, door trims, and center consoles, and, more particularly, to an apparatus for and method of manufacturing automotive instrument panels, door trims, center consoles and other automotive components to include fully or partially encapsulated electrical buttons, and other such sub-components.

b. Description of Related Art

Automotive interior components are often produced in a variety of manufacturing sequences based on the assembly requirements set forth by a manufacturer, and are also produced to a variety of specifications based on the quality and fit expected by customers. For automotive instrument panels and other such components, a zero gap fit appearance for sub-components such as electrical buttons and the like is generally indicative of a high quality product, whereas a fit having noticeable gaps is associated with a lower quality product.

As readily apparent, sub-components with a zero gap fit are generally more expensive from a design, manufacturing and assembly stand-point due to the tighter tolerances associated with such sub-components and the trim bezels required. These cost associated factors thus limit the use of such sub-components to luxury and high-end automobiles.

Exemplary manufacturing and attachment techniques for components such as electrical buttons include the incorporation of hooks on the buttons. The buttons may thus be inserted into appropriate apertures in an instrument panel, with the hooks being engaged with appropriate detents for retaining the buttons in place. As readily evident for such constructions, the apertures must be sized for adequate insertion or removal of buttons, and thus a predetermined gap exists while the button is in its rest configuration, or during actuation thereof. As further readily evident, in addition to being associated with non-luxury automobiles, such gaps can be a source of contamination which can eventually hinder movability of the electrical buttons and/or lead to associated electrical malfunctions.

It would therefore be of benefit to provide a method of manufacturing automotive instrument panels, door trims, center consoles and other automotive components to include sub-components such as electrical buttons having a zero gap appearance, while providing a new “cleaner” styling (associated with the elimination of trim panels) with reduced overall cost associated with such sub-components.

### SUMMARY OF THE INVENTION

The invention solves the problems and overcomes the drawbacks and deficiencies of prior automotive instrument panel manufacturing techniques by providing a method of manufacturing an automotive instrument panel including providing an electrical button, placing the button in a mold, and reaction injection molding a skin layer of the instrument panel to substantially fully encapsulate the button so that the button is substantially fully integrated with the skin layer and further includes a substantially zero gap fit with the instrument panel.

For the method described above, the full encapsulation eliminates a trim bezel on the button. In a particular embodiment of the present invention, a foam layer may be provided behind the skin layer. The method may further include substantially fully encapsulating electrical wiring associated with the button. The button may include coloration, label printing and/or back lighting visible through the skin layer.

The invention also provides a method of manufacturing an automotive instrument panel, with the method including providing an electrical button, placing the button in a mold, and reaction injection molding a skin layer of the instrument panel to partially encapsulate the button so that a face of the button is visible, an outer surface of the button is fully integrated with the skin layer, and the button includes a substantially zero gap fit with the instrument panel.

For the method described above, the full encapsulation eliminates a trim bezel on the button. The method may further include attaching a back part of the button in a mold lid or a front of the button in a mold bowl, providing the mold bowl with a hole for exposing a predetermined area of a front surface of the button, and placing the mold lid and mold bowl at a predetermined distance apart to provide a desired skin thickness adjacent the button. The method may also include accessing a back part of the button while the button remains within the skin for servicing the button, and removing and/or replacing the button from a front area of the instrument panel. For the method described above, the method may also include venting through one or more ports in the button for removing trapped air bubbles. The method may also include providing a foam layer behind the skin layer. The button may include one or more hooks engageable with a substrate for maintaining the button in a predetermined position relative to the skin layer.

The invention also provides a method of manufacturing an automotive instrument panel, with method including providing an electrical button, and advancing the electrical button within a skin of a reaction injection molding tool after injection and prior to reaction injection molding hardening.

For the method described above, the method may further include providing a foam layer behind the skin. The button may include one or more hooks engageable with a substrate for maintaining the button in a predetermined position relative to the skin.

The invention yet further provides an automotive instrument panel manufactured according to the aforementioned methods. For example, the automotive instrument panel may include an electrical button substantially fully encapsulated in a skin layer of the instrument panel and including a substantially zero gap fit with the instrument panel. The instrument panel may further include substantially fully encapsulated electrical wiring associated with the button, and the button may include coloration, label printing and/or back lighting visible through the skin layer. In another example, the automotive instrument panel may include an electrical button partially encapsulated in a skin layer of the instrument panel so that a face of the button is visible, an outer surface of the button is fully integrated with the skin layer, and the button includes a substantially zero gap fit with the instrument panel.

The invention also provides a method of manufacturing automotive instrument panels including forming a reaction injection molded skin with electrical button mounting features, mounting an electrical button directly in the skin so that features of the electrical button engage the electrical button mounting features, and urethane foam molding the skin and electrical button to a substrate. For the method described above, the method may further include venting through one or more ports in the button for removing trapped air bubbles, and trimming the port after the forming.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIGS. 1A and 1B are illustrative views of fully encapsulated electrical button surfaces, with the buttons being integrated into an automotive instrument panel skin according to the present invention manufacturing method;

FIG. 2 is an illustrative view of a partially encapsulated electrical button surface, with the button being integrated into an automotive instrument panel skin according to the present invention manufacturing method;

FIG. 3 is an illustrative view of a manufacturing stage according to the present invention;

FIGS. 4A and 4B are illustrative views of a reaction injection molding (RIM) air bubble entrainment defect control method, in which RIM material is vented at one or more ports in the button body;

FIGS. 5A and 5B are illustrative views of another RIM air bubble entrainment defect control method, in which the button is advanced just after the RIM material is injected, and just before it hardens;

FIGS. 6A-6E are illustrative views of a tightly fitting electrical button in an instrument panel surface as an alternative to encapsulation, with the button being integrated into an automotive instrument panel skin molded prior to button insertion according to the present invention manufacturing method;

FIG. 7 is an illustrative view of an assembly in which the button includes hooks;

FIGS. 8, 9A-9D and 10A-10D illustrate flow paths with and without venting;

FIGS. 11A-11C are respectively illustrative views of a fully encapsulated button during encapsulation, a button molded into a skin, and a final construction after urethane molding;

FIGS. 12A-12C are respectively illustrative views of an integrated button, a button molded into a skin, and a final construction, with the button having a rear exposed surface;

FIGS. 13A-13C are respectively illustrative views of an integrated button, a button molded into a skin, and a final construction, with the button having a front exposed surface; and

FIGS. 14A-14C are respectively illustrative views of an integrated button, a button molded into a skin, and a final construction, with the button having front and rear exposed surfaces.

### DETAILED DESCRIPTION OF THE PREFERRED EMBODIMENT

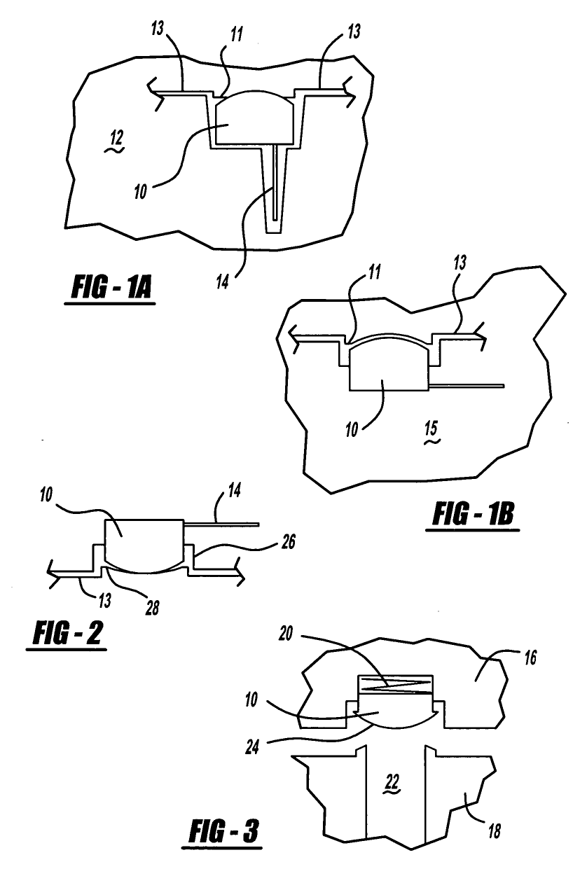

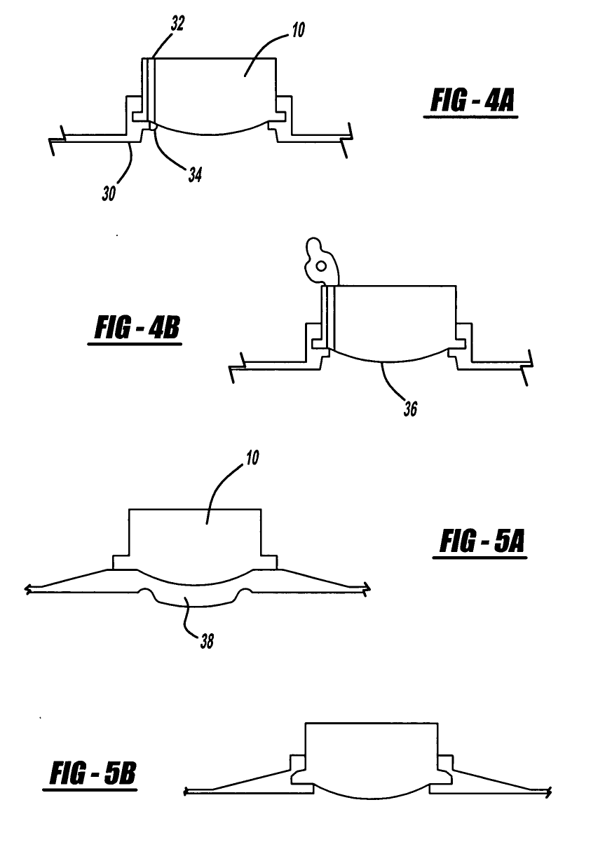

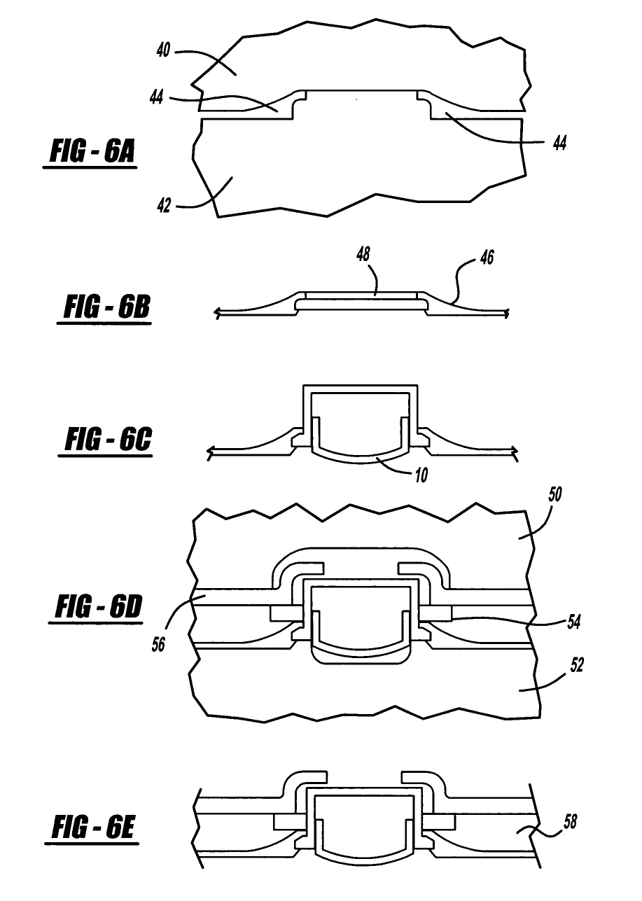

Referring now to the drawings wherein like reference numerals designate corresponding parts throughout the several views, FIGS. 1A-3 illustrate fully and partially encapsulated electrical buttons integrated into an automotive instrument panel skin according to the present invention manufacturing method, FIGS. 4A-5B are views illustrative of RIM air bubble entrainment defect control methods, and FIGS. 6A-14C are views illustrative of other constructions of encapsulated electrical buttons according to the present invention.

Specifically, the present invention provides a manufacturing method for fully or partially encapsulated electrical buttons and other such sub-components for automotive instrument panels, door trims, center consoles and the like. The manufacturing method may employ reaction injection molding (RIM), which is a process of molding plastic parts using liquid monomers (i.e. polyurethanes or foamed polyurethanes) by pumping the monomers into a mix head where they are combined under high pressure with isocynanate. During this process, the mixture fills the mold cavity under low pressure, and the monomers are polymerized into a solid mass by energy supplied by a chemical reaction. RIM thus allows for the production of parts with intricate detail, dimensional stability, and wear resistance, and allows for flowability for the encapsulation of a variety of inserts.

Referring now to FIG. 1A, an electrical button 10 may be disposed in a mold 12 and the button may be fully encapsulated by means of the RIM process discussed above for integration thereof into skin layer 13 of the instrument panel. For the configuration of FIG. 1A, the mold may include upper and lower mold halves (not shown), the internal surfaces of which may be respectively contoured to form the upper shape of skin layer 13, and the lower shape of skin layer 13 including the lower portion of button 10. An electrical wire 14 providing the electrical connection between button 10 and conventional electrical circuitry (not shown) may likewise be encapsulated. In this manner, button 10 may be completely encapsulated by bringing the upper and lower mold halves within a predetermined distance (i.e. the thickness of skin layer 13) for forming skin layer 13 and encapsulating button 10 and electrical wire 14. Encapsulated button 10 may thus include a ‘zero’ gap fit at interface 11 between the edge of the button and skin layer 13 of the instrument panel. Trim Bezels (the trim plates normally surrounding buttons mounted into larger components) are eliminated in this construction.

Referring to FIG. 1B, alternatively, button 10 may be disposed in a mold 15 and only the exposed surface of the button may be fully encapsulated during the RIM process discussed above. Electrical wire 14 providing the electrical connection between button 10 and conventional electrical circuitry (not shown) may be left exposed as shown. In this manner, the exposed surface of button 10 may be completely encapsulated and button 10 may thus be partially integrated into skin layer 13 to provide a ‘zero’ gap fit at interface 11 between the edge of the button and skin layer 13 of the instrument panel.

Button 10 may be any of a variety of buttons, such as automobile starter buttons, window up/down buttons, component on/off buttons, buttons opposite to a labeled trim plate, and other electrical or non-electrical switches as would be readily apparent to those skilled in the art.

Referring next to FIGS. 2 and 3, button 10 may alternatively be disposed in a mold including a mold lid 16 and a mold bowl 18, and the button may be partially encapsulated for partial integration into skin layer 13 during the RIM process discussed above to leave its outer surface exposed. For the RIM process, the button may be held in mold lid 16 by coiled wires 20 or other means. Mold bowl 18 may include a vacuum hole 22 sized for the exposed area 24 of button 10. During the manufacturing process, mold lid 16 and bowl 18 may be moved adjacent each other and maintained at a predetermined distance for providing a desired skin thickness 26. Hole 22 may be connected to a vacuum pump or blower (not shown) to seal the button face, preventing entry of liquid RIM material into the hole and for preventing the liquid material from covering the exposed surface of button 10, while still displaying the button surface (allowing for viewing the distinctive coloration, labeling and/or back lighting associated with automotive buttons).

As with the fully encapsulated button surface configuration of FIGS. 1A and 1B, electrical wire 14 providing the electrical connection between button 10 and conventional electrical circuitry (not shown) may likewise be encapsulated if needed. However, as shown in FIG. 2, wire 14 may be left exposed. In this manner, button 10 may be partially encapsulated to still provide a ‘zero’ gap fit at edges 28 thereof.

For the processes thus described above with reference to FIGS. 1A-3, the elimination of trim bezels by directly mounting buttons in the skin produces a “cleaner” styling appearance associated with higher quality assemblies.

Referring next to FIGS. 4A and 4B, these figures illustrate a RIM air bubble entrainment defect control method, in which RIM material is vented at one or more ports in the button body. Specifically, referring to FIG. 4A, a first RIM air bubble entrainment defect control method may include venting of RIM material 30 for button 10 by means of vent passage 32 provided in button 10. In use, a button with vent passage 32 allows for a potential bubble 34 in the RIM material to pass through as shown in FIG. 4B to thus provide a defect-free outer button surface 36.

Referring next to FIGS. 5A and 5B, these figures illustrate another RIM air bubble entrainment defect control method, in which the button is advanced just after the RIM material is injected, and just before it hardens. Specifically, as shown in FIG. 5A, button 10 may be advanced in RIM material fill 38 just before the material hardens to adequately distribute the RIM material around the button, and prevent defects as shown in FIG. 5B. The RIM material remaining over the button face may be removed after forming or left in place (depending on the style preferred).

Referring next to FIGS. 6A-6E, these figures illustrate views of a tightly fitting electrical button in an instrument panel surface as an alternative to encapsulation, with the button being integrated into an automotive instrument panel skin molded prior to button insertion. Specifically, as shown in FIG. 6A, a RIM tool may include an upper tool lid 40 and a lower tool bowl 42 including inner faces which may be brought together to define cavities 44. After injection of RIM material, skin 46 including aperture 48 is illustrated in FIG. 6B. As shown next in FIG. 6C, a button 10 may be inserted in aperture 48 after the skin is formed. Referring to FIG. 6D, the assembly of FIG. 6C may be loaded into a urethane foam tool, including a foam tool lid 50 and a foam tool bowl 52, and a soft seal ring 54 disposed against substrate 56. With urethane foam 58 being inserted in the area between substrate 56 and skin 46 as shown in FIG. 6E, the assembly may thus include an integrated button having a soft skin/foam layer.

Referring next to FIG. 7, for the assembly of FIGS. 6A-6E, the button may include hooks 60 disposed against substrate 56 for facilitating retention of button 10, as well as for maintaining skin layer 46 in the position illustrated by means of fingers 62.

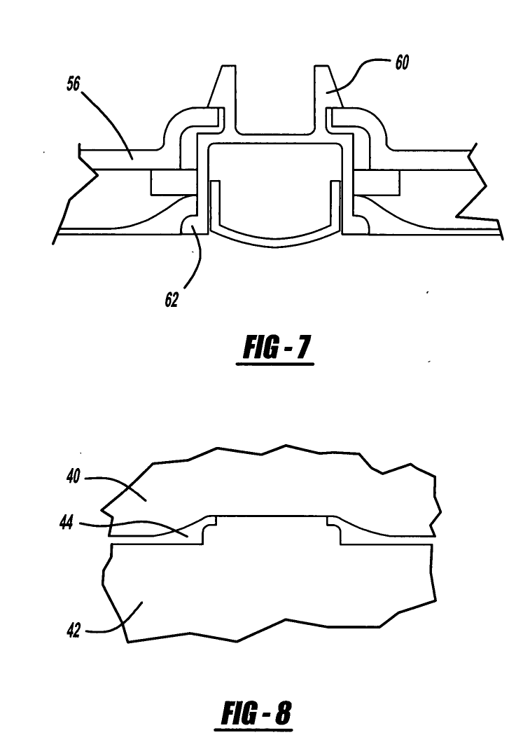

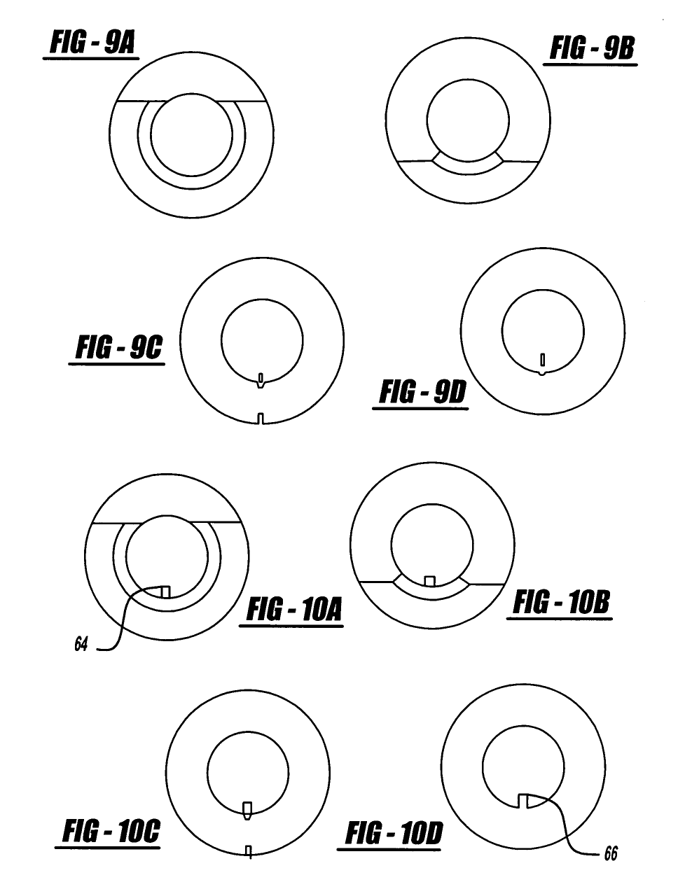

Referring next to FIGS. 8, 9A-D and 10A-D, these figures illustrate flow paths with and without venting. Specifically, FIG. 8 illustrates a RIM tool including an upper tool lid 40 and a lower tool bowl 42 including inner faces which may be brought together to define cavities 44. In a tool without a vent, the RIM material may flow as shown in FIGS. 9A-9D. As shown in FIG. 9C, as the opposing “bands” of the RIM material meet, the flow front may trap air to form a bubble. Referring next to FIGS. 10A-10D, if a vent 64 is provided in either upper tool lid 40 and a lower tool bowl 42, as the opposing “bands” of the RIM material meet, the flow front ends adjacent vent 64 which allows trapped air to be released. Any tab 66 created at vent 64 may be trimmed off as needed.

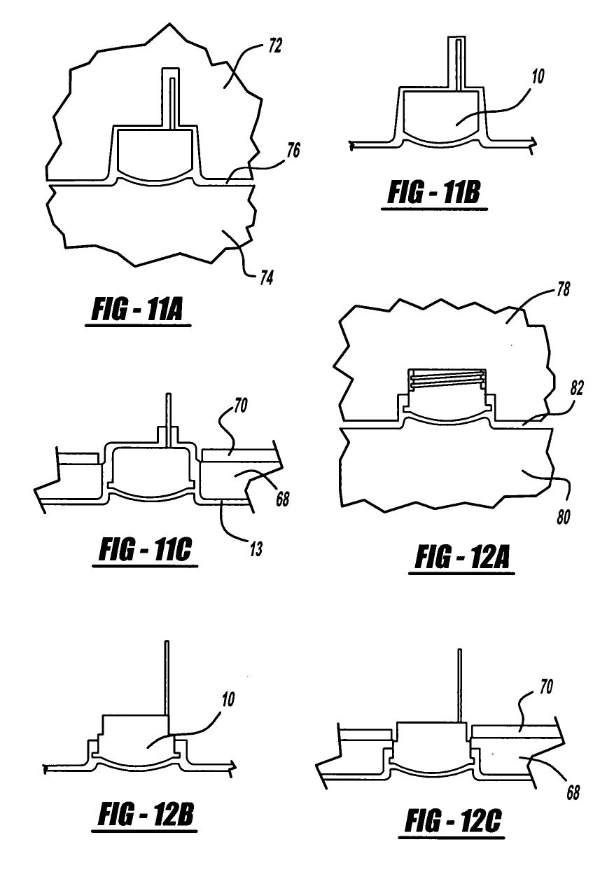

Referring next to FIGS. 11A-11C, these figures are illustrative views of a fully encapsulated button during encapsulation, a button molded into a skin, and a final construction after urethane molding. As shown in FIGS. 11A and 11B, similar to the construction of FIG. 1A, a button 10 may be fully encapsulated by means of the RIM process discussed above for integration thereof into skin layer 13 of the instrument panel. Thereafter the button encapsulation as shown in FIG. 11A and shown as formed in FIG. 11B may be urethane foamed to a substrate in FIG. 11C, and a foam layer 68 may be provided and sandwiched between skin layer 13 and substrate layer 70, to thus provide the skin layer with a soft feel. For the construction of FIG. 11A, a mold lid 72 may be disposed adjacent a mold bowl 74 for thus allowing the skin layer to be formed in cavity 76.

Referring next to FIGS. 12A-12C, these figures are illustrative views of an integrated button, a button molded into a skin, and a final construction, with the button having a rear exposed surface and wiring. As shown in FIGS. 12A and 12B, similar to the construction of FIG. 1B, a button 10 may be partially encapsulated by means of the RIM process discussed above for partial integration thereof into skin layer 13 of the instrument panel. However, compared to the construction of FIG. 1B, as shown in FIG. 12C, a foam layer 68 may be provided and sandwiched between skin layer 13 and substrate layer 70, to thus provide the skin layer with a soft feel. For the construction of FIG. 12A, a mold lid 78 may be disposed adjacent a mold bowl 80 for thus allowing the skin layer to be formed in cavity 82.

The constructions of FIGS. 11C and 12C may differ in that the rear surface of button 10 may be left exposed in FIG. 12C for allowing button serviceability.

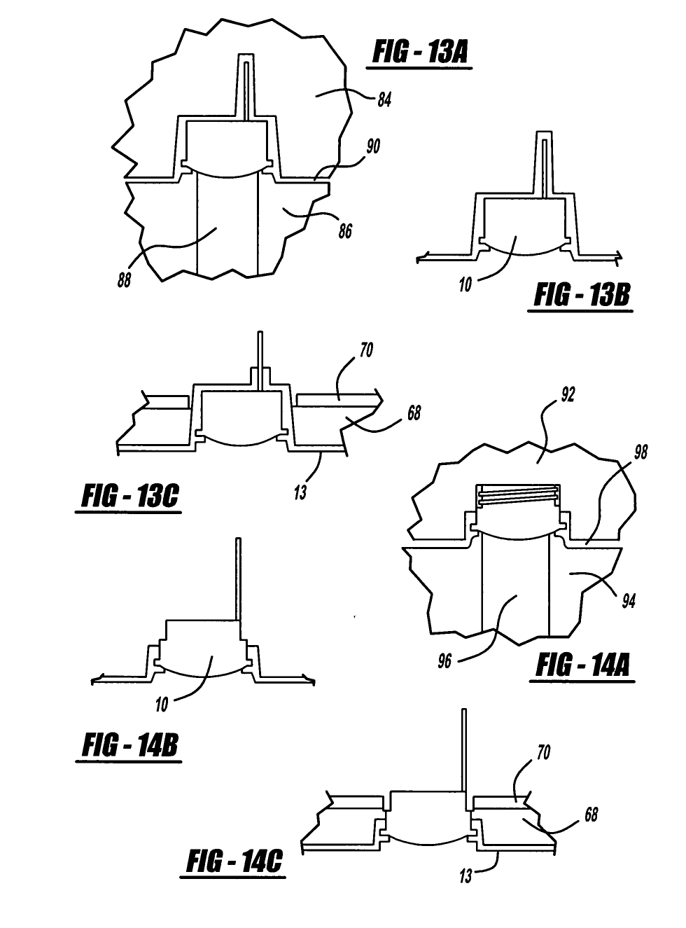

Referring next to FIGS. 13A-13C, these figures are illustrative views of an integrated button, a button molded into a skin, and a final construction, with the button having a front exposed surface. As shown in FIGS. 13A and 13B, similar to the construction of FIG. 2, a button 10 may be partially encapsulated by means of the RIM process discussed above for partial integration thereof into skin layer 13 of the instrument panel. However, compared to the construction of FIG. 2, as shown in FIG. 13C, a foam layer 68 may be provided and sandwiched between skin layer 13 and substrate layer 70, to thus provide the skin layer with a soft feel. For the construction of FIG. 13A, as illustrated for FIG. 3, a mold lid 84 may be disposed adjacent a mold bowl 86 including a vacuum hole 88 for thus allowing the skin layer to be formed in cavity 90.

FIGS. 14A-14C are illustrative views of an integrated button, a button molded into a skin, and a final construction, with the button having front and rear exposed surfaces. As shown in FIGS. 14A and 14B, similar to the construction of FIG. 3, a button 10 may be partially encapsulated by means of the RIM process discussed above for partial integration thereof into skin layer 13 of the instrument panel. However, compared to the construction of FIG. 3, as shown in FIG. 14C, a foam layer 68 may be provided and sandwiched between skin layer 13 and substrate layer 70, to thus provide the skin layer with a soft feel. For the construction of FIG. 14A, as illustrated for FIG. 3, a mold lid 92 may be disposed adjacent a mold bowl 94 including a vacuum hole 96 for thus allowing the skin layer to be formed in cavity 98.

The constructions of FIGS. 13C and 14C may differ in that the rear surface of button 10 may be left exposed in FIG. 14C for allowing button serviceability (so long as the RIM material only lightly adheres to the button).

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A method of manufacturing an automotive instrument panel, said method comprising:
providing an electrical button;
placing said button in a mold; and
reaction injection molding at least a skin layer of the instrument panel to substantially fully encapsulate said button so that said button is substantially fully integrated with the skin layer and further includes a substantially zero gap fit with the instrument panel.

2. A method according to claim 1, wherein said full encapsulation eliminates a trim bezel on said button.

3. A method according to claim 1, further comprising:
providing a foam layer behind the skin layer.

4. A method according to claim 1, further comprising substantially fully encapsulating electrical wiring associated with said button.

5. A method according to claim 1, wherein said button includes at least one of coloration, label printing and back lighting visible through the skin layer.

6. A method of manufacturing an automotive instrument panel, said method comprising:
providing an electrical button;
placing said button in a mold; and
reaction injection molding at least a skin layer of the instrument panel to partially encapsulate said button so that a face of said button is visible, an outer surface of said button is fully integrated with the skin layer, and said button includes a substantially zero gap fit with the instrument panel.

7. A method according to claim 6, wherein said full encapsulation eliminates a trim bezel on said button.

8. A method according to claim 6, wherein said button includes at least one of coloration, label printing and back lighting.

9. A method according to claim 6, further comprising:
attaching a back part of said button in a mold lid or a front of said button in a mold bowl;
providing the mold bowl with a hole for exposing a predetermined area of a front surface of said button; and
placing the mold lid and mold bowl at a predetermined distance apart to provide a desired skin thickness adjacent said button.

10. A method according to claim 6, further comprising at least one of:
accessing a back part of said button while said button remains within the skin for servicing said button; and
at least one of removing and replacing said button from a front area of the instrument panel.

11. A method according to claim 6, further comprising:
venting through at least one port in said button for removing trapped air bubbles.

12. A method according to claim 6, further comprising:
providing a foam layer behind the skin layer.

13. A method according to claim 6, wherein said button includes at least one hook engageable with a substrate for maintaining said button in a predetermined position relative to the skin layer.

14. An automotive instrument panel manufactured according to the method of claim 6.

15. A method of manufacturing an automotive instrument panel, said method comprising:
providing an electrical button; and
advancing said electrical button within a skin of a reaction injection molding tool after injection and prior to reaction injection molding hardening.

16. A method according to claim 15, further comprising:
providing a foam layer behind the skin.

17. A method according to claim 15, wherein said button includes at least one hook engageable with a substrate for maintaining said button in a predetermined position relative to the skin.

18. An automotive instrument panel comprising:
an electrical button substantially fully encapsulated in a skin layer of said instrument panel and including a substantially zero gap fit with said instrument panel.

19. An automotive instrument panel according to claim 18, further comprising substantially fully encapsulated electrical wiring associated with said button.

20. An automotive instrument panel according to claim 18, wherein said button includes at least one of coloration, label printing and back lighting visible through the skin layer.

21. An automotive instrument panel comprising:
an electrical button partially encapsulated in a skin layer of said instrument panel so that a face of said button is visible, an outer surface of said button is fully integrated with said skin layer, and said button includes a substantially zero gap fit with said instrument panel.

22. An automotive instrument panel according to claim 21, wherein said button includes at least one of coloration, label printing and back lighting.

23. A method of manufacturing automotive instrument panels, said method comprising:
forming a reaction injection molded skin with electrical button mounting features;
mounting an electrical button directly in said skin so that features of said electrical button engage said electrical button mounting features; and
urethane foam molding said skin and electrical button to a substrate.

24. A method according to claim 23, further comprising:
venting through at least one port in said button for removing trapped air bubbles; and
trimming said port after said forming.
